(19) United States
(12) Patent Application Publication
(10) Pub. No.: US 2013/0341069 A1
(43) Pub. Date: Dec. 26, 2013

(54) Electrically Insulating Electrical Rotation Coupling Device and Tool Adaptor Comprising Such a Device

(71) Applicant: Thierry Demaretz, Grandpuits (FR)

(72) Inventor: Thierry Demaretz, Grandpuits (FR)

(73) Assignee: STANLEY WORKS (EUROPE) GMBH, Dubendorf (CH)

(21) Appl. No.: 13/984,054

(22) PCT Filed: Jan. 26, 2012
(86) PCT No.: PCT/EP12/51235

§ 371 Date: Sep. 16, 2013

(30) Foreign Application Priority Data
Feb. 8, 2011 (FR) 1100388

(51) Int. Cl. H02G 1/00

(52) U.S. Cl. CPC H02G 1/00
USPC 174/138 R

(57) ABSTRACT

The coupling device (10) comprises a first head (12) having at least one male part (26); a second head (14) having at least one associated female part (42); and an intermediate member (16) which electrically insulates said male and female parts. The intermediate member (16) comprises a transverse partition (62), arranged according to the entirety of the assembly joint between the first and the second head (12; 14).

Use for an adapter for a tool used for installing or maintaining batteries for powering electric vehicles.

The present invention relates to an electrically insulating rotational coupling device, comprising a first and a second coupling head extending in a substantially straight line along a longitudinal axis, the first head comprising at least one male part extending substantially axially, and the second head comprising at least one associated axial female part which cooperates therewith to transmit the torque; an intermediate member comprising electrical insulation means arranged such that the male and female torque transmission parts are electrically insulated from each other.

In the field of electricity or electromechanics, it is common to use electrically insulated tools to carry out work on members under electric voltage. The operators using insulated tools work on these members in satisfactory safety conditions.

In any case, the insulated tools do not prevent the risks of electrical damage to electronic equipment arranged upstream of the tool which is insulated with respect to the members under electric voltage arranged downstream of said tool.

U.S. Pat. No. 2,025,838 discloses coupling two ends of shafts aligned in a resilient manner and insulated by means of a transmission member in a non-metallic material introduced between two coacting coupling heads. The purpose of the transmission member is to electrically insulate said heads from each other. However, such a device is not intended to withstand a high electric field and does not allow the equipment to be effectively protected.

The object of the invention is that of improving the electrical protection of a coupling device.

For this purpose, the subject matter of the invention is an electrically insulating coupling device of the above-mentioned type, characterised in that the intermediate member comprises an electrically insulating partition which is transverse to the longitudinal axis and arranged according to the entirety of the assembly joint between the first and the second head.

Therefore, the invention ensures reliable insulation against electric arcs.

According to other features:
the electrical insulation means and the transverse electrically insulating partition of the intermediate member are formed in one piece;
the first and/or the second head is/are a steel machined part(s) and the intermediate member is a moulded part made of a plastics material having a high dielectric strength.

The present invention also relates to an adapter capable of being coupled to at least one tool, the adapter comprising a drive end capable of being connected to a first driving tool, in particular a screwing machine, and a driven end capable of being connected to a second driven tool, in particular a screw bushing, characterised in that it comprises a coupling device of the above-mentioned type.

According to other features:
the first and the second head each comprise a drive end having a female profile, and a driven end having a male profile;
the adapter comprises, in addition, an outer coating made of electrically insulating material, in particular comprising one or more layers obtained by immersion coating.

The present invention also relates to the use of an adapter of the above-mentioned type for screwing or unscrewing members kept under an electric voltage which is less than or equal to 1000 volts in alternating current and less than or equal to 1500 volts in direct current, in particular for installing or maintaining batteries for powering electric vehicles.

The invention and its advantages can be better understood by reading the following description, given solely by way of example and with reference to the appended drawings, in which:

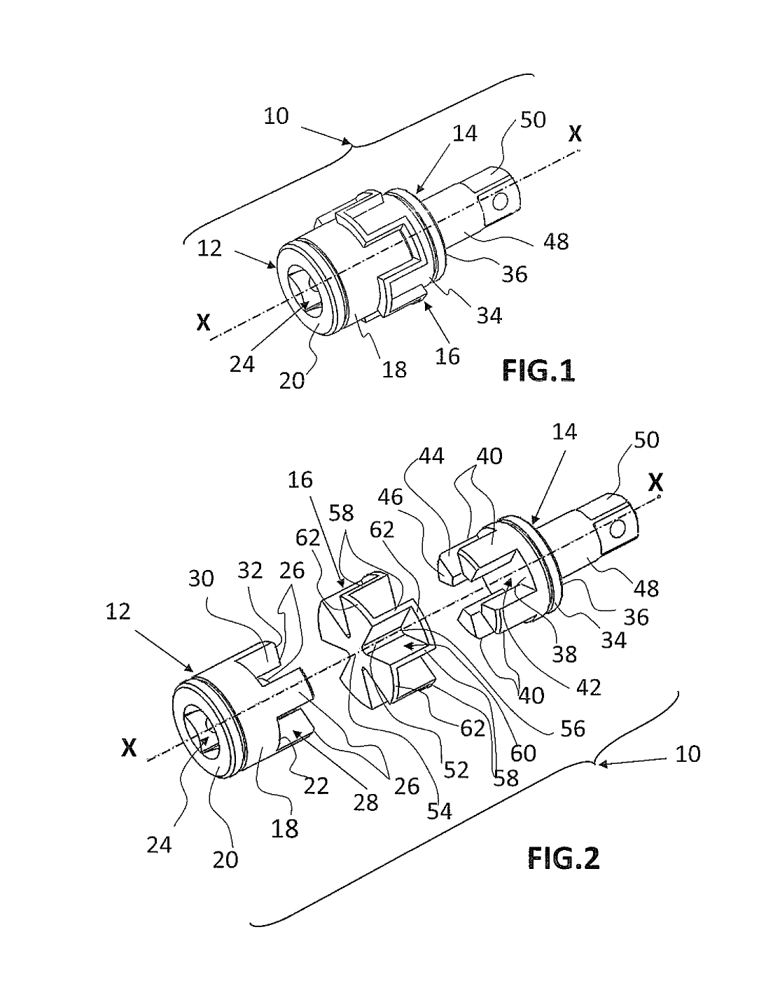

FIGS. 1 and 2 are a perspective view and an exploded view respectively of a coupling device according to the invention,

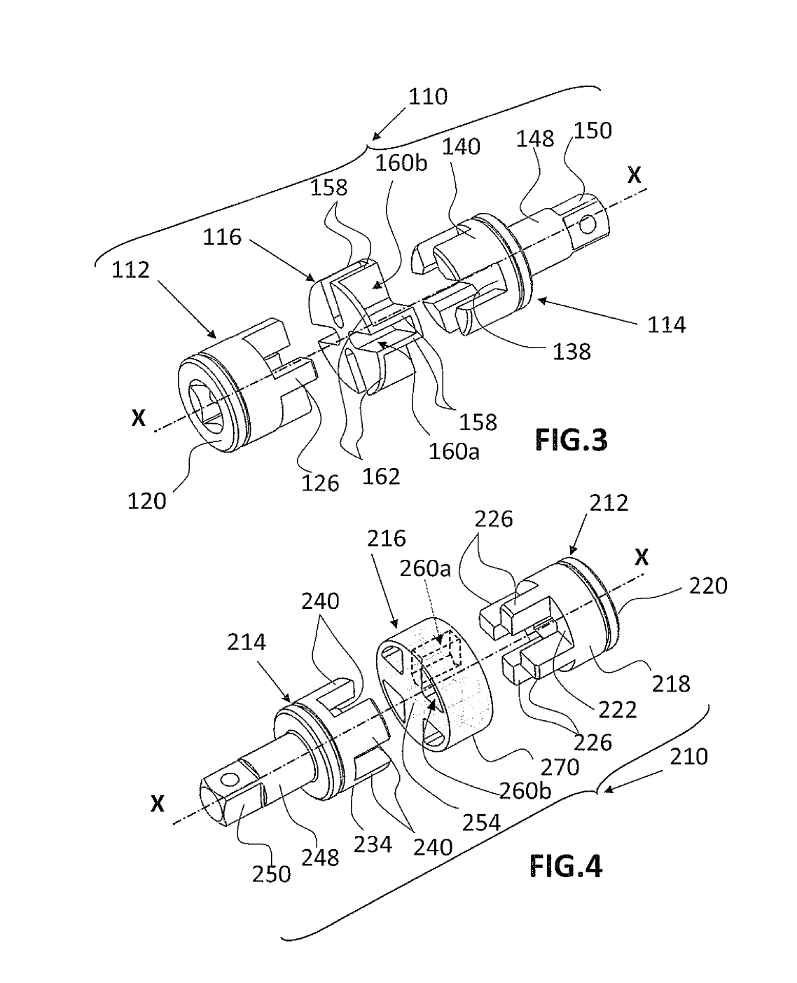

FIG. 3 is a view similar to FIG. 2 of a first variant of the device according to the invention,

FIG. 4 is a view similar to FIG. 2, oriented in the opposite direction, of a second variant of the device according to the invention,

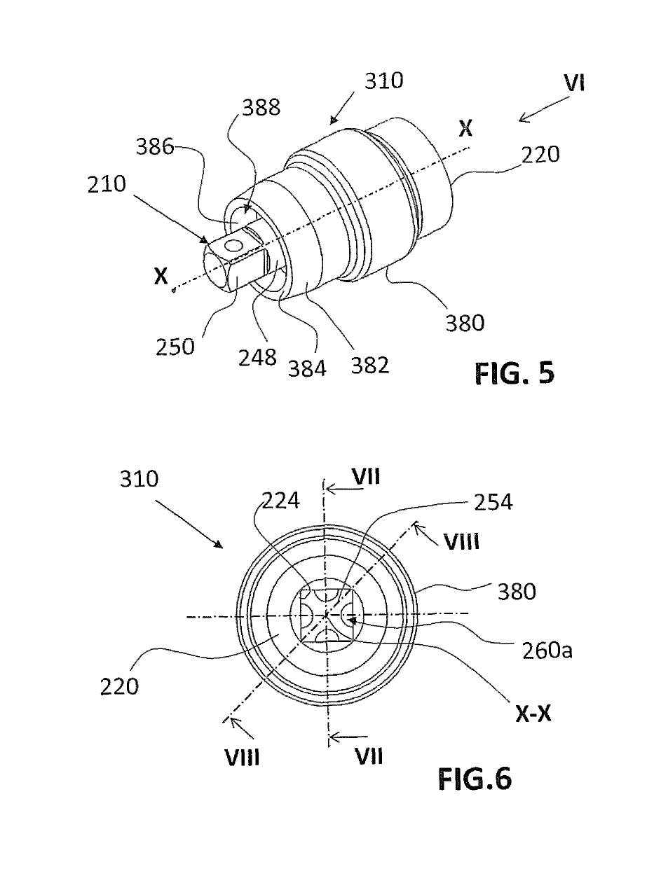

FIG. 5 is a perspective view of an adapter comprising the coupling device in FIG. 4,

FIG. 6 is a side view according to the arrow VI in FIG. 5,

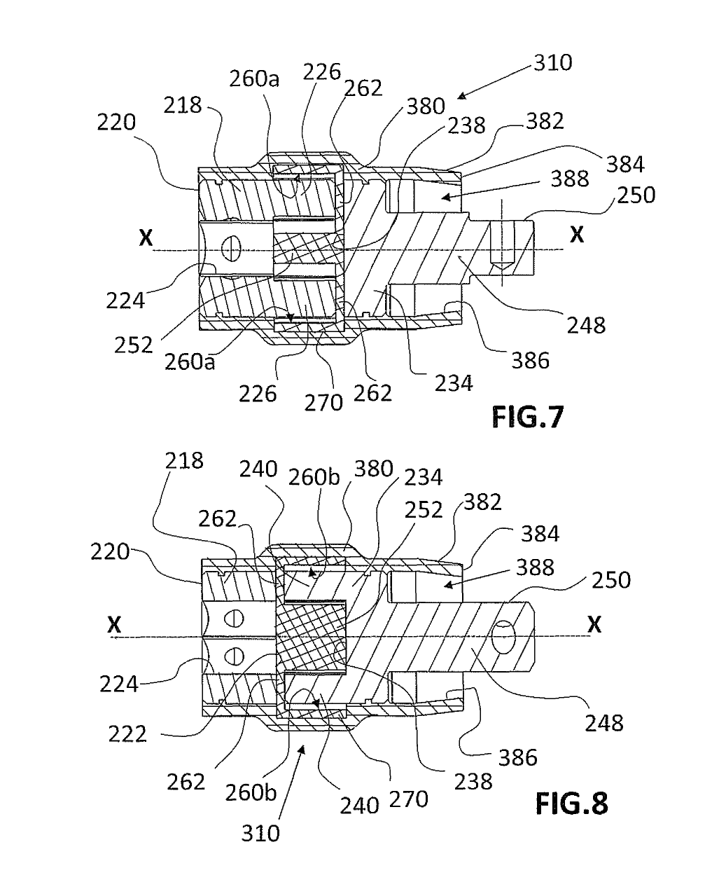

FIG. 7 is a cross-sectional view along line VII in FIG. 6,

FIG. 8 is a cross-sectional view along line VIII in FIG. 6.

The terms “inner” and “outer” used in the following description are to be understood according to the orientation of the assembly in FIGS. 1 to 5, 7 and 8.

FIGS. 1 and 2 show a rotational coupling device 10 suitable for coupling, in a working position, a driving machine and a driven object (not shown).

The device 10 extends along a longitudinal axis X-X. Said device comprises a first head 12 defining a part driving in rotation with respect to the axis X-X, and a second head 14 defining a part driven in rotation with respect to the same axis, the heads being substantially aligned along the axis X-X. Each of the heads 12 or 14 is made of metal and is produced, preferably in one piece by machining, from steel.

The device 10 also comprises an intermediate member 16 which is arranged so as to be assembled between the heads 12 and 14. The object of said device is that of transmitting the torque of the first head 12 to the second head 14, and to electrically insulate said heads from each other. The intermediate member 16 is non-metallic and is moulded, preferably in one piece, from plastics material having a high dielectric strength so as to achieve effective electrical insulation, in particular from PETP (polyethylene terephthalate) or from PEEK (polyether ether ketone).

The driving head 12 comprises a substantially cylindrical body 18 delimited by a first outer face 20 and a second inner face 22 (FIG. 2), the two faces being substantially perpendicular to the axis X-X.

The outer face 20 comprises a coupling means 24 in the form of a cavity having a female profile which has a square cross-section.

At least one lug 26 (FIG. 2), preferably a plurality of lugs, in particular four lugs 26 (FIG. 2), is/are arranged so as to project axially from the inner face 22 along the axis X-X. The lugs 26 in FIG. 2 are identical, are in the shape of a toroidal element having a rectangular cross-section and have a cross-section which is transverse with respect to the axis X-X in the shape of an angle sector of approximately 45°.The axial dimensions thereof are equal. The lugs 26 are distributed in an equidistant manner at an angle with respect to the axis X-X. Therefore, a lug 26 is adjacent to a recess 28 which is also in the shape of an identical angle sector but has a greater transverse dimension than the lug. For the sake of clarity in FIG. 2, only one of the recesses 28 has a reference sign. Each lug 26 primarily comprises two radial lateral faces 30 and a transverse free end face 32.

The driven head 14 also comprises a substantially cylindrical body 34 delimited by a first outer face 36 and a second inner face 38 (FIG. 2), the two faces being substantially perpendicular to the axis X-X.

At least one lug 40 (FIG. 2), preferably a plurality of lugs identical in number to the lugs 26 of the head 12, in particular four lugs 40 (FIG. 2), is/are arranged so as to project axially from the inner face 38 along the axis X-X. The lugs 40 of the head 14 are substantially identical to the lugs 26 of the head 12 and are distributed in the same manner with respect to the axis X-X. The axial dimensions thereof are equal. A lug 40 is adjacent to a recess 42 which is in the general shape of an identical angle sector but has a greater transverse dimension than the lug. For the sake of clarity in FIG. 2, only one of the recesses 42 has a reference sign. Each lug 40 primarily comprises two radial lateral faces 44 and a transverse free end face 46.

A cylindrical shaft 48 projects axially with respect to the outer face 36 of the head 14 along the axis X-X. The free end of the shaft 48 comprises a coupling means 50 in the shape of a male profile having a square cross-section.

The intermediate transmission member 16 firstly has complementary shapes designed to cooperate, with slight play, with the or each lug 26 and the or each recess 28 of the head 12 and, secondly, complementary shapes designed to cooperate, likewise with slight play, with the or each lug 40 and the or each recess 42 of the head 14.

For this purpose, the intermediate member 16 comprises a central portion 52 extending axially along the axis X-X and delimited by two transverse end faces 54 and 56.

At least two ribs 58 (FIG. 2), preferably a plurality of ribs, the number of which is equal to twice the number of lugs, in particular eight ribs 58 (in FIG. 2, only four ribs are visible and have reference signs), extend from the central portion 52 radially with respect to the axis X-X and axially from the end face 54 to the end face 56. The ribs 58 are distributed in an equidistant manner at an angle with respect to the axis X-X.

The intermediate member 16 comprises at least one receiving housing 60 which separates two adjacent ribs 58, preferably a plurality of housings, the number of which is equal to twice the number of lugs, in particular eight housings 60 (FIG. 2). For the sake of clarity in FIG. 2, only one of the housings 60 has a reference sign.

The first and the second head 12 and 14 are arranged such that the or each lug of one of the first or the second body 18 and 34 is received, by means of axial insertion and with play, in a corresponding recess of the other of said first or second body with which it is associated, the ribs 58 of the intermediate member 16 being interposed between the or each lug 26 of the first body 18 and the or each adjacent lug 40 of the second body 34 such that the heads 12 and 14 are electrically insulated from each other.

The structure of the coupling device 10 is such that the housings 60 of the intermediate member 16 are suitable for alternately receiving the or one of the lugs 26 of the driving head 12 and the or one of the lugs 40 of the driven head 14 by means of axial insertion.

In this way, each rib 58 keeps the respective lateral faces 30 and 44 of the adjacent lugs 26 and 40 at a distance, electrically insulating said lateral faces from each other.

The axial dimension of the intermediate member 16 is such that, after the axial insertion of the member 16 between the two heads 12 and 14, the free end face 32 of each lug 26 of the head 12 is at a distance from the inner face 38 of the body 34 of the head 14 corresponding to the bottom of the associated recess 42, and such that the free end face 46 of each lug 40 of the head 14 is likewise kept at a distance from the inner face 22 of the body 18 of the head 12 corresponding to the bottom of the associated recess 28.

The intermediate member 16 comprises an electrically insulating partition 62 which is transverse with respect to the axis X-X and arranged according to the entirety of the assembly joint between the first and the second head 12 and 14.

For this purpose, the intermediate member 16 comprises at least one partition 62, preferably a plurality of partitions which are equal in number to the ribs, in particular eight partitions 62 (in FIG. 2, only three partitions 62 are visible and have reference signs) arranged transversely with respect to the axis X-X. They occupy the spaces between, firstly, the lug(s) 26 and the bottom of the associated recess 42 and, secondly, the lug(s) 40 and the bottom of the associated recess 28. Each partition 62 extends from the central portion 52 to the free end of a rib 58 and connects two adjacent ribs 58. The partitions 62 are arranged alternately in the extension of each of the end faces 54 and 56 of the portion 52. In other words, for two adjacent housings 60, one is open on the end face 54 of the intermediate member 16 and the other on the opposite end face 56.

The thickness of the ribs 58 and the thickness of the partitions 62 are substantially equal.

The intermediate member 16 is formed in one piece, is compact, and acts as a continuous and electrically insulating barrier between the heads 12 and 14. In addition, the free ends of the ribs 58 and partitions 62 are, at the assembly joint, in relief (FIG. 1) with respect to the outer surface of the heads 12 and 14, which ensures effective insulation against electric arcs.

The coupling device 110 in FIG. 3 represents a variant of the device 10 in FIGS. 1 and 2. In order to facilitate understanding, the numerical reference signs of the elements which keep their function are preserved and increased by 100.

The coupling device 110 differs from the device 10 in that the respective lugs 126 and 140 of the heads 112 and 114 do not have the same cross-section, that is to say that the cross-section of the lugs 126 is rectangular, whereas that of the lugs 140 is in the shape of an angle sector of approximately 90°. As a result, the housings 160a of the intermediate member 116 suitable for receiving the lugs 126 of the head 112 in a complementary manner have a different shape and dimension to the housings 160b of the same member suitable for receiving the lugs 140 of the head 114 in a complementary manner. For the sake of clarity in FIG. 3, only one of the housings 160a and only one of the housings 160b have reference signs.

The radial ribs 158 are arranged symmetrically in parallel in pairs. The intermediate member 116 acts in the same manner as above as a continuous, electrically insulating barrier between the heads 112 and 114.

The coupling device 210 in FIG. 4 represents another variant of the device 10 in FIGS. 1 and 2. In order to facilitate understanding, the numerical reference signs of the elements which keep their function are preserved and increased by 200.

The coupling device 210 differs from the device 110 in that the intermediate member 216 comprises, in addition, a circular and continuous outer peripheral wall 270, having a thickness which is substantially equal to that of the ribs and the partitions and connects the outer radial ends thereof. The intermediate member 216 has a cylindrical shape, the outer diameter of which is slightly greater than that of the respective bodies 218 and 234 of the heads 212 and 214. After it has been assembled between the bodies 218 and 234, the intermediate member 216 covers said bodies in part opposite the assembly joint.

The invention also relates to an adapter 310, shown in FIGS. 5 to 8 and suitable for being coupled to at least one tool, the adapter comprising a drive end suitable for being connected to a first driving tool, in particular a screwing machine, and a driven end suitable for being connected to a second driven tool, in particular a screw bushing. The adapter 310 comprises one of the above-mentioned electrically insulating coupling devices 10, 110, 210, preferably the coupling device 210 (FIG. 4) which has a circular and continuous peripheral wall 270 (FIGS. 7 and 8). For the sake of clarity in FIG. 4, only one of the housings 260a (shown in dashed lines) and only one of the housings 260b have reference signs.

The adapter 310 comprises a thick outer insulating coating 380 which can comprise one or more layers of different colours of PVC (polyvinyl chloride) which serve to electrically insulate the operator of the adapter. The coating 380 is obtained by dip coating and is integral with the outer surface of the coupling device 210, with the exception of the two ends of the device comprising the coupling means, that is to say the outer face 220 of the head 212 and the shaft 248 of the head 214. A skirt 382 axially extends the coating 380 externally around the shaft 248, the free end 384 of the skirt 382 being set back axially with respect to the male driving square profile 250. The inner face 386 of the skirt 382 is at a distance from the shaft 248, creating a space 388 which allows the insulating skirt 382 to be overlapped by another insulated tool (not shown), such as a bushing, assembled at the male driving square 250.

The adapter 310, which is simultaneously insulating and insulated, is used for screwing or unscrewing members kept under an electric voltage which is less than or equal to 1000 volts in alternating current or less than or equal to 1500 volts in direct current, in particular for installing or maintaining batteries for powering electric vehicles.

In the above-mentioned embodiment, the insulating coating and the intermediate member are two separate elements. In a variant which is not shown, the outer insulating coating is formed in one piece which is integrally formed with the intermediate member by overmoulding a suitable plastics material on the heads.

In the description above, the adapter comprises two metal heads and coupling means comprising male and female driving squares. Only one of the heads can be metal, and other types of coupling can be produced.

Owing to the invention, users work safely with respect to possible electric shocks and the installations in which these users carry out work are protected against possible damage linked to an electric arc. In addition, the coupling device and the adapter for the corresponding tool are simple, compact, and economical in terms of production costs.

1. Electrically insulating rotational coupling device (10; 110; 210), comprising a first (12; 112;
212) and a second (14; 114; 214) coupling head extending in a substantially straight line along a longitudinal axis (X-X), the first head comprising at least one male part (26; 126; 226) extending substantially axially, and the second head comprising at least one associated axial female part (42; 142; 242) which cooperates therewith to transmit the torque; an intermediate member (16; 116; 216) comprising electrical insulation means (52, 54, 56, 58) arranged such that the male (26; 126; 226) and female (42; 142; 242) torque transmission parts are electrically insulated from each other, characterised in that the intermediate member (16; 116; 216) comprises an electrically insulating partition (62; 162; 262) which is transverse with respect to the longitudinal axis (X-X) and arranged according to the entirety of the assembly joint between the first (12; 112; 212) and the second (14; 114; 214) head.

2. Device according to claim 1, characterised in that the electrical insulation means (52, 54, 56, 58) and the transverse electrically insulating partition (62; 162; 262) of the intermediate member (16; 116; 216) are formed in one piece.

3. Device according to either claim 1 or claim 2, characterised in that the first (12; 112; 212) and/or the second (14; 114; 214) head is/are a steel machined part(s) and in that the intermediate member (16; 116; 216) is a moulded part made of a plastics material having a high dielectric strength.

4. Adapter (310) capable of being coupled to at least one tool, the adapter comprising a drive end (24; 124; 224) capable of being connected to a first driving tool, in particular a screwing machine, and a driven end (50; 150; 250) capable of being connected to a second driven tool, in particular a screw bushing, characterised in that it comprises a coupling device (10; 110; 210) according to any of claims 1 to 3.

5. Adapter according to claim 4, characterised in that the first (12; 112; 212) and the second (14; 114; 214) head each comprise a drive end having a female profile (24; 124; 224), and a driven end having a male profile (50; 150; 250).

6. Adapter according to either claim 4 or claim 5, characterised in that said adapter comprises, in addition, an outer coating (380) made of electrically insulating material, in particular comprising one or more layers obtained by dip coating.

7. Use of an adapter (310) according to any of claims 4 to 6 for screwing or unscrewing members kept under an electric voltage which is less than or equal to 1000 volts in alternating current and less than or equal to 1500 volts in direct current, in particular for installing or maintaining batteries for powering electric vehicles.
